(19) United States
(12) Patent Application Publication
(10) Pub. No.: US 2008/0264912 A1
(43) Pub. Date: Oct. 30, 2008

(54) Gas Mixture For Laser Beam Fusion Cutting

(75) Inventors: Wolfgang Danzer, Dorfen (DE); Ernst Miklos, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/596,632

(22) PCT Filed: May 20, 2005
(86) PCT No.: PCT/EP2005/005503

§ 371 Date: Jun. 17, 2008

(30) Foreign Application Priority Data
May 27, 2004 (DE) 10 2004 026 033.8

(51) Int. Cl. B23K 26/14; C01B 3/02

(52) U.S. Cl. 219/121.72; 252/374

(57) ABSTRACT

A gas mixture for laser beam fusion cutting is disclosed. The gas mixture essentially contains N₂ and smaller fractions of O₂ and H₂. The gas can be produced in an extremely cost-effective manner by the enrichment of a starting product consisting of impure nitrogen that contains 1-6% O₂ with H₂.

This application claims the priority of International Application No. PCT/EP2005/005503, filed May 20, 2005, and German Patent Document No. 10 2004 026 033.8, filed May 27, 2004, the disclosures of which are expressly incorporated by reference herein.

### BACKGROUND AND SUMMARY OF THE INVENTION

The invention relates to a gas mixture for laser beam fusion cutting. The invention further relates to a method for laser beam fusion cutting of materials, wherein a focused laser beam is guided on the surface of the work piece being processed and a cutting gas stream is directed against the surface of the work piece via at least one jet.

The properties of the laser beam, particularly intensity and good focusability, have led to lasers being used nowadays in many fields of material processing. Laser beam processing facilities are known as such. As a rule, they feature a laser processing head, possibly with a jet arranged coaxially to the laser beam. Laser processing facilities are often used in connection with CNC controls of guidance machines for the x-y cutting direction. More and more frequently manipulation systems of three-dimensional work pieces are being used with laser beam cutting. An automatic allocation of cutting parameters (laser performance adapted to the respective cutting speed during the cutting process) related to the contour shape being cut is, as a rule, a precondition for a good cutting quality also on sharp corners and acute angles.

Laser beam cutting is the most frequently used laser processing method on a world-wide basis. For example, over 80% of the laser processing facilities in Germany are used for cutting. In the case of laser beam cutting, a distinction is made between the variations of laser beam flame cutting (with oxygen), laser beam fusion cutting (with inert gas or nitrogen) and reactive laser beam cutting (with reacting gases like hydrogen and oxygen, which introduce energy to the work site through the detonating gas reaction). These types of methods and gas mixtures are known from German Patent Document No. DE 100 64 327 A1 or No. DE 693 17 313 T2, for example.

In laser beam fusion cutting, the work piece is melted in the separating spot by the laser beam. The melt is expelled from the kerf with a cutting gas. Laser beam fusion cutting with high-pressure cutting gas has gained acceptance in the cutting of high-grade steels, but is also used to some extent for other materials such as structural steels or aluminum. Normally, an inert gas such as nitrogen, in particular, is used as a cutting gas for laser beam fusion cutting.

In laser beam fusion cutting of metals, particularly when cutting chromium nickel steels, nitrogen is used, wherein this gas should have the highest possible freedom from oxygen, in order to avoid an oxidation of the cut surfaces. Nitrogen that is highly pure (less than 1% oxygen) or that has the highest purity (less than 0.1% O₂) is required precisely in cutting chromium nickel steels or electro-steel sheets that have greater thicknesses. Gases with such purity are generated by cryogenic air separation since PSA or VSA facilities (pressure swing adsorption, vacuum swing adsorption, adsorptive separations of air in nitrogen and oxygen) generate initial products in the manufacture of nitrogen, which have a higher proportion of O₂. In the case of adsorption facilities, gases with a higher level of purity can also be generated, but then the production rate (m³/h) drops drastically.

The object of the invention is to propose a gas mixture for laser beam fusion cutting, which is cheaper than high-purity nitrogen and which offers the same cutting speeds and cutting qualities as a high-purity nitrogen.

### DETAILED DESCRIPTION OF THE EXEMPLARY EMBODIMENTS

According to the invention, instead of high-purity nitrogen, an impure initial product is used, which originates, e.g., from a VSA facility, an adsorption facility, a PSA facility, an on-site facility, a membrane separation facility or another air separation facility, and typically contains 91-96% nitrogen, approx. 1% argon and approx. 2-6% oxygen. This type of gas can be manufactured very economically. To create good cutting quality and obtain a high cutting speed, in accordance with the invention, a small quantity of hydrogen is added, which apparently reduces the remaining oxygen and makes it harmless. By adding small quantities of hydrogen to the cutting gas with approx. 3% oxygen, one ends up with the same oxide-free cut in the kerf as when using a nitrogen with 0.1% oxygen. In the case of thinner sheets, which almost do not get hot during cutting and therefore also hardly scale, very little hydrogen must be added. With sheet thicknesses above 3 mm, a greater addition of hydrogen is required.

The addition of hydrogen can correspond to the oxygen content of the initial gas or be greater (e.g., up to 12% if 6% oxygen is allowed). This would be a stoichiometric addition of hydrogen. Experiments were successful with the hyperstoichiometric addition of H₂, i.e., more than twice as much H₂ as O₂.

The invention permits a qualitatively high-quality and reproducible cutting with increased cutting speed. Laser beam fusion cutting in accordance with the invention has been shown to be reliable for the process.

Furthermore, the invention leads to an improvement in perforation during laser beam fusion cutting.

As a rule, the invention does not necessitate any modifications of existing laser equipment and fittings.

The invention can be used in connection with all types of lasers. It is suited above all for use in laser processing with Nd YAG lasers, diode lasers, and CO₂ lasers.

If, in the case of a commercially available PSA facility, the oxygen in the air (21%) is reduced to approx. 3%, one obtains a gas mixture with 96% nitrogen, 1% argon and 3% oxygen; in doing so, the production of this gas lies at approx. 100 m³/h. If one wants to reduce the oxygen content to 0.1% with the same facility (which many cutting users require), then this same facility will now produce 30 m³/h. The cost of manufacturing the same quantity of gas is therefore three times as high. According to the invention, a cutting gas that achieves a cut that is just as oxide-free at the same cutting speed can now be generated by adding hydrogen to the considerably cheaper PSA initial product having lower purity.

1-5. (canceled)

6. A gas mixture for laser beam fusion cutting, containing essentially N₂ and smaller portions of O₂ and H₂, wherein impure nitrogen with 1-6% O₂ as an initial product is enriched with H₂.

7. The gas mixture according to claim 6, wherein the gas mixture includes:
91-97% N₂;
1-6% O₂;
0.5-1% argon; and
0.1-12% H₂.

8. The gas mixture according to claim 7, wherein the gas mixture includes:
93-95% N₂;
1-3% O₂; and
0.1-6% H₂.

9. The gas mixture according to claim 6, wherein the gas mixture includes approximately 93% nitrogen, approximately 3% oxygen, approximately 1% argon, and approximately 3% hydrogen.

10. Use of a gas mixture according to claim 6 for cutting chrome nickel steels or electro-steel sheets.

11. Use of a gas mixture according to claim 10, wherein the chrome nickel steels or electro-steel sheets have thicknesses >3 mm.

12. A method to produce the gas mixture according to claim 6, wherein the initial product is from a nitrogen plant and is enriched with the H₂.

13. The method according to claim 12, wherein the nitrogen plant is a PSA nitrogen plant.

14. A method for laser beam fusion cutting, comprising the steps of:
adding H₂ to a gas mixture containing N₂ and O₂ in a percentage of 1-6% O₂ to form a cutting gas; and
laser bean fusion cutting a workpiece using the cutting gas.

15. The method according to claim 14, wherein the workpiece is comprised of chromium nickel steel.

16. The method according to claim 15, wherein a thickness of the chromium nickel steel is greater than 3 mm.

17. The method according to claim 14, wherein the step of adding H₂ to the gas mixture containing N₂ and O₂ in the percentage of 1-6% O₂ to form the cutting gas is performed by an adsorption facility.

18. The method according to claim 14, wherein an amount of H₂ added to the gas mixture is two times an amount of O₂ in the gas mixture.

19. The method according to claim 14, wherein an amount of H₂ added to the gas mixture is more than two times an amount of O₂ in the gas mixture.
